(19) United States
(12) Patent Application Publication
(10) Pub. No.: US 2009/0151172 A1
(43) Pub. Date: Jun. 18, 2009

(54) Double Handle Kitchen Knife

(76) Inventor: Brian William Hayes, Homer, AK (US)

Correspondence Address: BRIAN WILLIAM HAYES, 840 SHORE RD, APT 4E, LONG BEACH, NY, 11561, US

(21) Appl. No.: 12/389,040

(22) Filed: Feb. 19, 2009

Related U.S. Application Data
(63) Continuation-in-part of application No. PCT/US08/83372, filed on Nov. 13, 2008.
Application No. PCT/US08/83372 is a continuation of application No. 12/258,384, filed on Oct. 24, 2008.
Application No. 12/258,384 is a continuation of application No. 12/134,208, filed on Jun. 6, 2008.
Application No. 12/134,208 is a continuation of application No. 12/198,893, filed on Aug. 27, 2008.
Application No. 12/198,893 is a continuation of application No. 11/949,782, filed on Dec. 4, 2007.

(51) Int. Cl. B26B 29/02; B25G 3/00

(52) U.S. Cl. 30/295; 30/340

(57) ABSTRACT

Double handle knives and attachments to convert a knife to a double handle knife are described with secondary handles able to form an angle (a) between about 20 to 70 degrees between the long axis of the secondary handle and the long axis of the blade in a plane at about right angles to the blade. Embodiments describe fixed, rotatable, and indexable means for the angle of attachment of the secondary handle to the blade. Embodiments further describe reversible and permanent means of attachment. The placement of the secondary handle at the angle described allows for the optimal positioning of the hands for both controlling and assisting with the cutting of foods and other items.

### CROSS-REFERENCES TO RELATED APPLICATIONS

This application is a continuation-in-part and claims priority under 35 U.S.C. 120 of PCT/US08/83372, filed on Nov. 13, 2008, entitled Double Handle Kitchen Knife, which is a continuation-in-part of U.S. patent application Ser. No. 12/258,384, filed on Oct. 24, 2008, entitled Double Handle Kitchen knife, which is a continuation-in-part of U.S. patent application Ser. No. 12/198,893, filed on Aug. 27, 2008, entitled Double Handle Kitchen Knife, which is a continuation-in-part of U.S. application Ser. No. 12/134,208, filed on Jun. 6, 2008, entitled Double Handle Kitchen Knife, which is a continuation-in-part of U.S. patent application Ser. No. 11/949,782, filed Dec. 4, 2007, entitled Double Handle Kitchen Knife.

### REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of Invention

This invention refers to double handle kitchen knives and handle attachments to convert a knife into a double handle knife, and specifically to improvements in the function of the secondary handle that allow for greater ease and accuracy in the cutting of food items and other objects.

2. Background of Invention

The vast majority of kitchen knives in use today employ conventional handles extending off the back end of a blade whereas the front of the blade comes to a point. These knives allow a user to grip the knife with their dominant hand leaving their non-dominant hand free to control the food item or other object being cut. This arrangement allows precise cutting of the food item but has the disadvantage that the dominant hand is doing most of the work. This often leads to hand and wrist fatigue especially for the elderly, people predisposed to wrist injury, and others who prepare a lot of difficult to cut foods such as carrots, squash, pumpkins, potatoes, frozen foods, and so forth. To help alleviate this, people sometimes use their non-dominant hand to assist their dominant hand in cutting through a food item. This may be done by positioning the food item with the palm and thumb of the non-dominant hand while simultaneously using the index and middle fingers of the same to press down on the top front of a blade, gripping the handle with the dominant hand and raising it to clear the food item, then levering down cutting through it with the assistance of the non-dominant hand. However, pressing down on the top of the thin knife blade with the fingers can be very uncomfortable and limits the downward force that is possible.

Double handle knives, in addition to a primary handle used by the dominant hand, provide a secondary handle for use by the non-dominant hand so that both hands can comfortably apply downward pressure on broad handles. Using the four available fingers (thumb excluded) of the non-dominant hand to press down evenly on the secondary handle would provide maximum benefit and minimize hand and wrist fatigue. However none of the prior art double handle knives provide secondary handles designed for the dual purpose of allowing the palm and thumb of the non-dominant hand to remain close to the blade to control short pieces of food while also leaving the remaining four fingers of the same hand in a position to press down evenly on the secondary handle. This includes those that require both hands to wrap around the handles as disclosed in patents: A. Haas U.S. Pat. No. 986,166 and Li Xiaoping Chinese Pat. No. CN2247586Y with vertical handle grips; Watermolen and Peters U.S. Pat. No. 5,920,992 with rising handles with finger grips; Wang Xiaobo Japanese Pat. No. JP11300058 and John Erikson U.S. Pat. No. 1,706,918 with a secondary handle built on the back top of a knife blade; W. L. Iwan U.S. Pat. No. 696,050 with handles at right angles at the back of the blade.

Dexter-Russell (Product no. 09210) makes a double handle “cheese knife” with a conventional design handle on each end as well as a handle attachment (product no. 18000) for adding an additional handle to pizza knives. This attachment may conceivably be used to attach to a kitchen knife as well. Additionally, Carl. Carrillo U.S. Pat. No. 6,493,946 made a knife guard that can be applied to the top of a blade and used as an secondary handle. With these designs, the long axis of the secondary handle is parallel to the blade. However, a parallel arrangement (see FIG. 2C) is not ideally suited for the dual purpose of pinning down the front of the knife and assisting in the cut while also positioning the food item for the cut as there is a tendency for the index finger to exert significantly greater downward pressure than the other fingers and for other reasons as discussed in the primary operation of the main embodiment.

Barker and Barbour U.S. Pat. No. 230,393 developed a handle attachment that adds an additional handle to knives intended for cutting cheese. The handle design is very high profile and not suited for both assisting in the cutting and controlling of food items by the non-dominant hand. Furthermore, the long axis of the handle is perpendicular to the blade. A perpendicular arrangement (see FIG. 2D) is not ideally suited for the dual purpose of assisting in the cut while also controlling the food item as the fingers are unevenly placed on the handle creating unnecessary side torque as downward pressure is applied. The dominant hand would have to counteract this torque to keep the knife blade straight thus creating more stress on the wrists.

J. P. Smith U.S. Pat. No. 331,915 developed a knife having a conventional handle on one end and a high profile round handle extending off the top of a blade. The high profile handle makes it convenient for cutting high blocks of cheese but more difficult for the dual purpose of both cutting and controlling food items with the non-dominant hand. Furthermore, a round handle doesn't provide an ideal arrangement for the dual purpose of both positioning the food item and levering maximum downward pressure to cut it: because if a round handle was large enough to accommodate all four fingers of the non-dominant hand, over 3″ diameter, the fingers would be mostly contacting the handle on one side of the knife blade thereby creating side torque as downward pressure is applied (see FIG. 2E).

Yet another limitation of the prior art is when the non-dominant hand is not required for controlling the food item or other object: now that the non-dominant hand and arm are free to assume a variety of positions to find the one most effective for the given situation, they are limited by the fixed position of the secondary handle itself. This is especially true with harder to cut items.

### SUMMARY OF INVENTION

### Objects and Advantages

Accordingly, several objects and advantages of the main embodiment of my invention are:
(a) to provide a double handle knife with a secondary handle that may be positioned such that four fingers of the non-dominant hand may evenly press down on it while leaving the palm and thumb of the same hand in optimal position to control the food item being cut;
(b) to provide a double handle knife with a secondary handle which pivots thereby allowing versatility in the positions that the non-dominant hand and arm may assume for assisting in the cutting of food items especially in those situations in which the non-dominant hand is not needed for positioning the same;
(c) to provide means that secondary handles of differing designs can be easily exchanged on the same knife thus further increasing its versatility;
(d) to provide means for easy secondary handle removal to facilitate one-handed operation of the knife as well as making it easier for cleaning, sharpening and storage of the knife;

Further objects and advantages of additional embodiments are:
(a) to provide a double handle knife or secondary handle attachment with permanent or reversible means to attach a secondary handle at an indexable or fixed angle to the blade at an optimal angle.

Still further objects and advantages will become apparent from a consideration of the ensuing description and drawings.

### BRIEF DESCRIPTION OF THE DRAWINGS

Note that the specification relating to the following embodiments should be construed as an exemplary rather than as a limitative of the present invention, with many variations and modifications being readily attainable by a person of average skill in the art without departing from the spirit or scope thereof.

FIGS. 1A and 1B illustrate the basic components of the main embodiment of a rotating secondary handle knife design shown in fully assembled side elevation view in FIG. 1A and shown in detail view of FIG. 1B.

FIGS. 2A, 2B, 2C, 2D, and 2E are top plan views which illustrate the main embodiment of a double handle knife in use with the non-dominant hand on a secondary handle, controlling and assisting in the cutting of a food item as in FIG. 2A, depiction of the angle formed between secondary handle and blade as in FIG. 2B, and positions of a user's hand on the secondary handle controlling and cutting a food item in parallel position as in FIG. 2C, perpendicular position as in FIG. 2D, and on a round handle as in FIG. 2E.

FIGS. 3A and 3B illustrate perspective views of a rotating double handle knife with a clamping body providing a reversible means to clamp the pivot post and secondary handle to the blade as in FIG. 3A and a rotating secondary handle attachment for conversion of a single handle knife into a rotating double handle knife as in FIG. 3B.

FIG. 4A is an exploded perspective view which illustrates a quick release mechanism to release the pivot post and modifications to the blade which facilitate the attachment and positioning of the quick release mechanism.

FIG. 4B is a close-up exploded detail perspective view of the quick release mechanism of FIG. 4A.

FIGS. 5A, 5B, and 5C illustrate additional embodiments of secondary handle design such as a bi-level version as in FIG. 5A, a crosswise-grip version as in FIG. 5B, a T-grip version as in FIG. 5C, and a safety-handle version as in FIG. 5D.

FIG. 6A is a side elevation view of an embodiment for pressure plate means consisting of a magnetic base mounting unit for the secondary handle.

FIG. 6B is a exploded detail perspective view of magnetic base mounting unit of FIG. 6A.

FIGS. 7A and 7B illustrate embodiments of fixed angle secondary handle designs such as a double handle knife with fixed angle secondary handle as shown in the close-up perspective views of FIG. 7A (exploded) and FIG. 7B and the fixed angle secondary handle attachment as shown in the perspective view in FIGS. 7C (exploded) and 7D.

FIG. 8A is a close-up exploded perspective view which illustrates an embodiment of a double handle knife with a rotatable handle which attaches directly to a tang on the knife blade.

FIG. 8B is a close-up exploded perspective view which illustrates an embodiment of a double handle knife with tang over which a pivot post is cast.

FIG. 9A is an exploded detail perspective view of an embodiment of a tensioner mechanism.

FIG. 9B is a close-up side-elevation view of an tensioner with O-ring groove.

FIG. 10 is a close-up exploded perspective view that illustrates an embodiment of a double handle knife having indexable rotation means of a splined post and secondary handle with internal splines.

FIG. 11 is an exploded close-up perspective view of an embodiment of a double handle knife in which the secondary handle rotation is limited by pivot post tabs and handle slots.

FIG. 12A is a bottom view of an embodiment of a secondary handle having indexable rotation means of attachment with secondary handle slots that attaches to a tang of a blade.

FIG. 12B is a close-up exploded perspective view of a double handle knife with indexable rotation means of secondary handle attachment to a square post attached to a blade.

### DRAWINGS—LIST OF REFERENCE NUMERALS

10 blade
12 primary handle
14 pivot post
16 slot
18 press pad—secondary handle version
20 hole
21 carrot food item
22 round handle
40 rotating secondary handle attachment
42 pivot post
44 clamping body
46 slot
48 Allen head set screw
50 blade
52 hole
56 lower mounting unit
58 slot
60 body
62 blind holes
64 pins
66 spring
70 end plate
72 release knob
74 connecting rods
80 secondary handle—bi-level version
82 lower section
84 hole
86 cross-member
88 upper section
90 secondary handle—crosswise-grip version
92 base
94 hole
96 bracket
98 handle grip
100 secondary handle—T-grip version
101 round handle grip
102 base
103 hole
104 thin connecting member
105 safety secondary handle
106 secondary handle
107 safety guard
109 rounded outer surface
110 magnetic mounting unit
112 housing
114 slot
116 fixed flat bar magnet
118 floating flat bar magnet
120 backing plate
122 retracting rod
124 knob
126 side plate
130 fixed angle secondary handle
132 blade
134 tang
140 fixed angle secondary handle attachment
142 clamping body
144 slot
146 tang and retainer
148 Allen screw
150 secondary handle
152 bushing
154 internal slot
156 tang
158 blade
166 second handle
168 hole
170 post
172 internal slot
180 secondary handle
182 tensioner hole
184 hole
186 tension band with thread housing
188 tensioner knob
190 band
200 O-ring
202 O-ring groove
204 pivot post
206 blade
210 splined post
212 blade
214 secondary handle
216 internal splines
220 pivot post
222 pivot post tabs
224 secondary handle
226 handle grooves
230 secondary handle
232 slots
242 square post
246 second handle
248 square hole

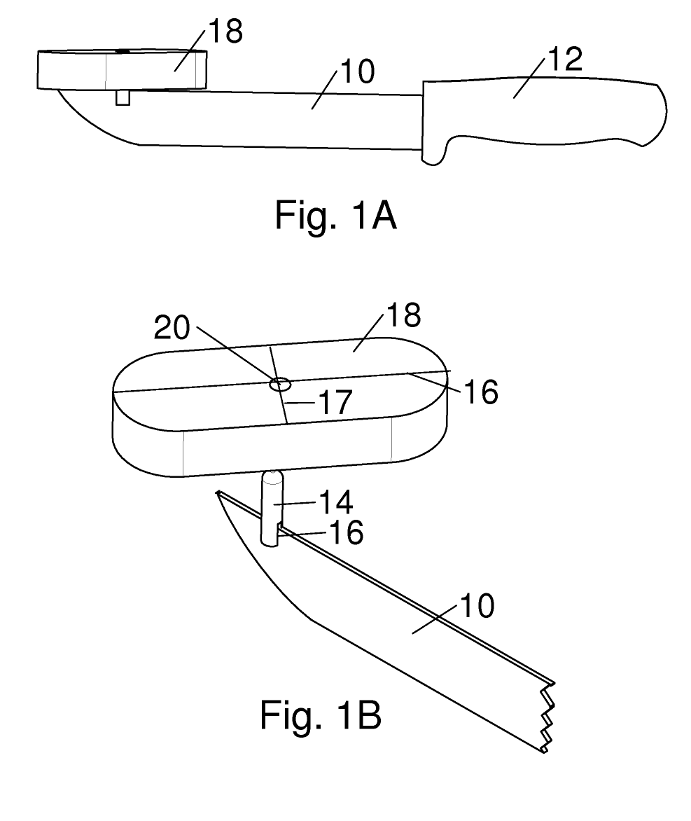

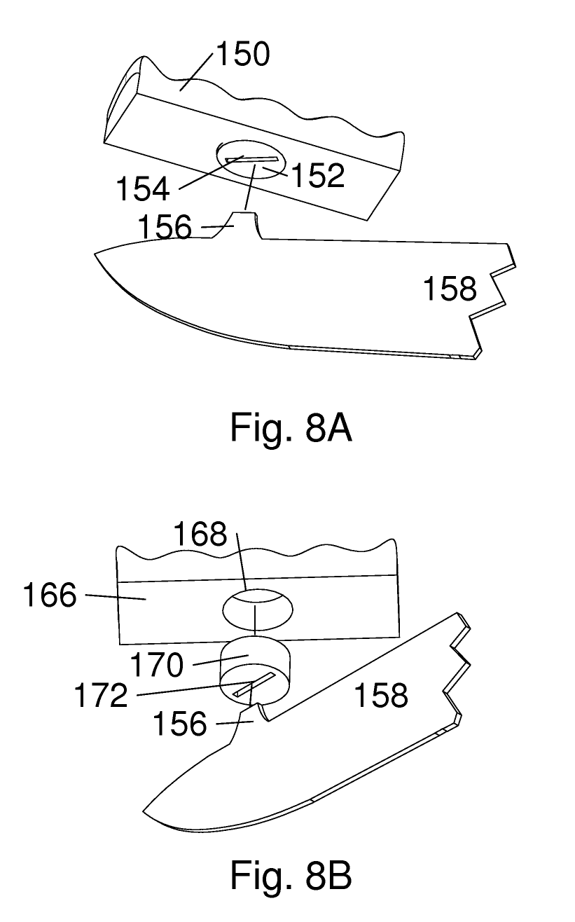

The main embodiment of the present invention is illustrated in FIGS. 1A and 1B: fully assembled in side view in FIG. 1A and a front close up in FIG. 1B. At the back of blade 10 a primary handle 12 is fastened (FIG. 1A). Primary handle 12 may be of a conventional design. A pivot post 14 (FIG. 1B) of stainless steel round bar may be slotted 15 to fit over the top front of blade 10 and fastened by riveting, welding, soldering or other permanent means. Alternatively, the post may be cast or forged integral with the blade or a post may be fitted over a tang (see FIG. 8B). The blade may be made out of steel, ceramic, or other materials. A secondary handle 18 has a length or long axis 16 preferable greater than three inches to enable all four fingers (thumb excluded) of the non-dominant hand to press down on it and a width or short axis 17 having sufficient surface for the fingers to comfortably press down on but preferably less than two inches as wider widths introduce unnecessary side load as discussed below for the primary operation of the main embodiment.

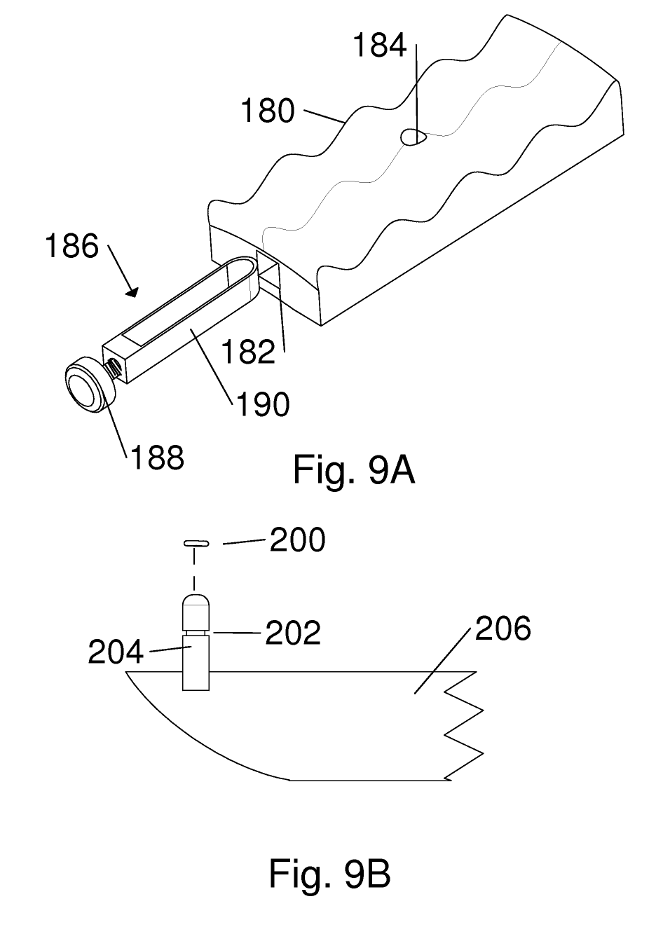

Secondary handle 18 may be wooden or plastic, smooth or with finger slots on top and has a centrally located hole 20 (FIG. 1B) of close tolerance to pivot post 14 to enable rotating on pivot post 14 when assembled. The secondary handle may rest on the blade and has a height sufficient to accommodate the pivot post as lower profiles facilitate the cutting method as described in the primary operation of the main embodiment. The pivot post arrangement allows ready removal of secondary handle for cleaning, storage and sharpening of the blade 10. Furthermore, the close tolerance prevents secondary handle 18 from slipping off when the present invention is turned upside down but may be retained by fasteners which allow the handle 14 to still rotate such as a spring loaded ball bearing built into post 14 and a corresponding groove in hole 20, an O-ring fitted into a groove in post 14, or a flanged bolt which threads down into the top of the pivot post to retain the handle while still allowing it rotate. Optional tensioners to moderate the free rotation of the secondary handle are shown in FIGS. 9A and 9B. The handle may also carry a simple set screw to lock it in position against the pivot post if the same angle of handle rotation is required repeatedly. The secondary handle 18 may further carry a bearing or bushing insert with an inner diameter to match the pivot post outer diameter. The shape of the secondary handle 18 may be flattened rectangular, oblong, a piece of round bar, etc.

Furthermore, the pivot post may be mounted perpendicular to the long axis of blade 10, centered or parallel to a plane of the blade 10 as shown in FIG. 1 A and B, thereby enabling pivoting of the secondary handle 18 in a plane above the top of the knife and at about right angles to a plane of the blade. As there are many means to attach the secondary handle 18 to the top of the blade 10 in a rotating fashion, the design presented above is not intended to limit the scope of the invention.

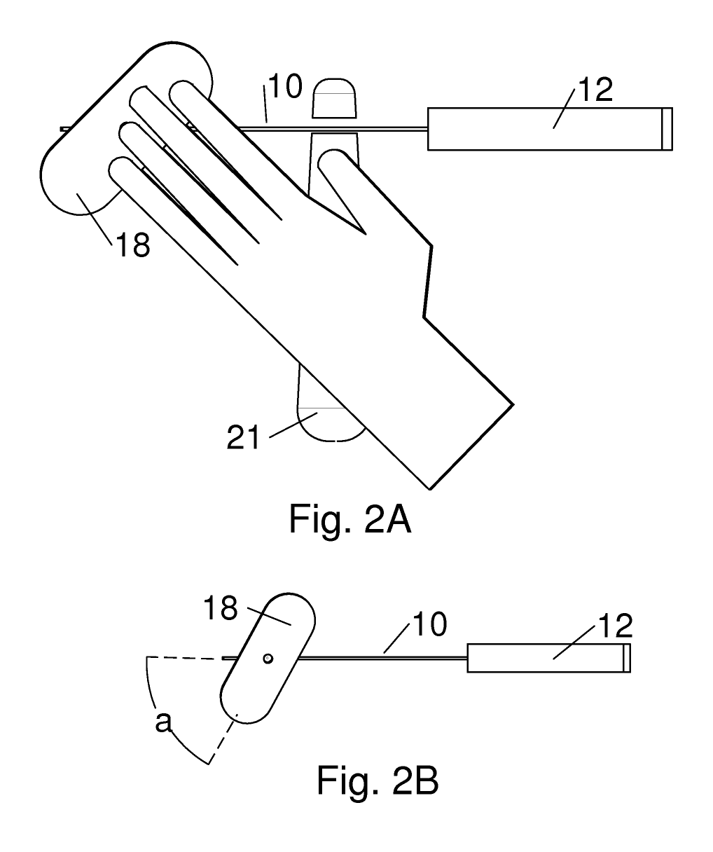

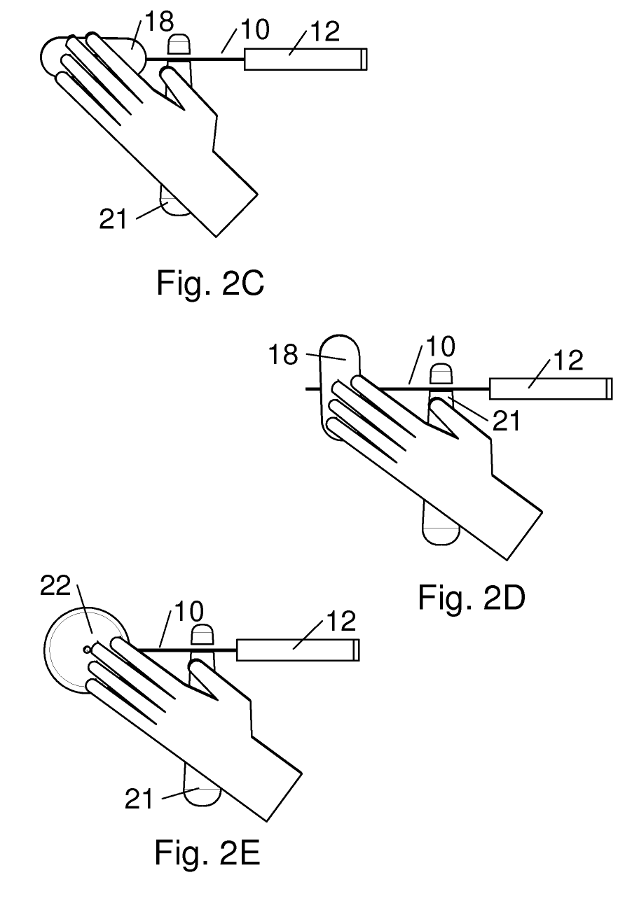

The operation of the main embodiment is illustrated in FIG. 2A (top view) showing the general positions of the user's non-dominant hand, secondary handle 18, object being cut (carrot 21 shown as example), knife blade 10, and primary handle 12. The palm and thumb of the non-dominant hand are kept close to blade 10 to position the object being cut whereas the four remaining fingers of the same hand press down on the secondary handle 18. The dominant hand grips primary handle 12 in typical fashion raising it to clear over the food item being cut, then pressing down to cut as the fingers on secondary handle 18 simultaneously press down the front of blade 10 and assist the dominant hand in cutting through the food item or other object. Secondary handle 18 may be free to rotate 360 degrees. However, using this method of assisting with the cut and positioning food with the non-dominant hand the ideal angle (a) (FIG. 2B) formed between the long axis of secondary handle 18 to the long axis of blade 10 for a right handed person is between about 20 and 70 degrees in a plane about perpendicular to the blade. For a dominant left handed person the secondary handle 18 is simply rotated around and the corresponding angle (a) of the handle on the other side of the blade is employed. The unique arrangement of these embodiments in this position allow the fingers to be positioned more evenly over both sides of blade 10 providing downward leverage with minimal side torque while still allowing the palm and thumb to be close to blade 10 to position even short food items. Furthermore, the fingertips instead of the base of the fingers can be used to apply even and balanced downward pressure on the secondary handle. This utilizes the full length of the non-dominant hand and therefore maximizes the flexibility thereof as the fingertips on the secondary handle rise when the back of the knife is raised to clear the food item while simultaneously having the palm and thumb pin down the food item.

Other positions are less beneficial for using the cutting method described above. In double handle knives in which a secondary handle is mounted parallel to a blade, angle (a) is 0 degrees as shown in FIG. 2C. This position maximizes hand twisting as the index finger travels up and down more than the other fingers as the front of the knife remains pinned to the board and the back of the knife rises to clear the food item and then lowers to cut through it. Furthermore, the pinky finger has minimal or no contact with the secondary handle whereas the base of the index finger contacts the secondary handle causing the index finger to naturally exert significantly greater downward pressure than the other fingers. These factors increase the potential for hand and wrist strain.

For a handle in a position perpendicular to the blade where angle (a) is 90 degrees as shown in FIG. 2D and for a round handle 22 able to accommodate four fingers as shown in FIG. 2E significant side torque is introduced because the fingers press down more on one side of the handle. This increases the likelihood for hand and wrist strain when cutting difficult objects.

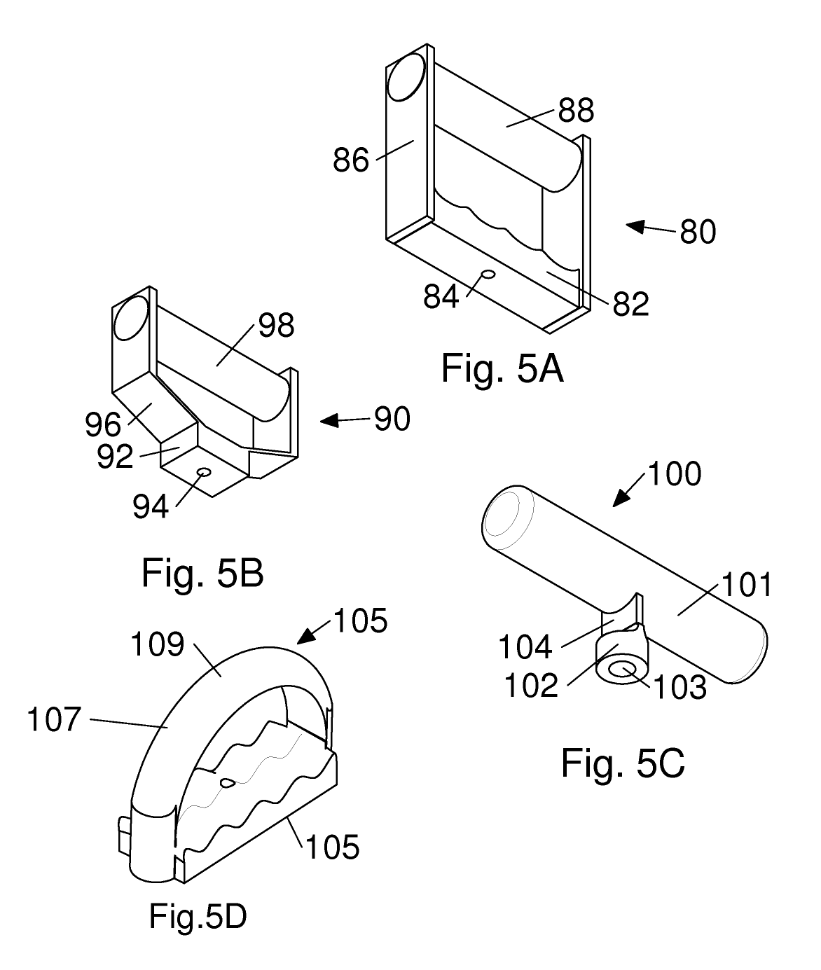

The rotating double handle knife as described may allow all angles of the secondary handle relative to the knife blade to be quickly assumed which can be a highly useful feature when the non-dominant hand is not required to control the object being cut. Pressing down firmly on the secondary handle with the non-dominant hand can be done with the handle rotated to the best position that a particular cutting chore warrants, thereby extending the range of positions possible and minimizing arm and wrist fatigue especially for repetitive chopping chores or cutting difficult items like frozen foods. Alternative handles designs can further enhance this function as shown in the operation and advantages illustrated in FIGS. 5A, 5B, and 5C.

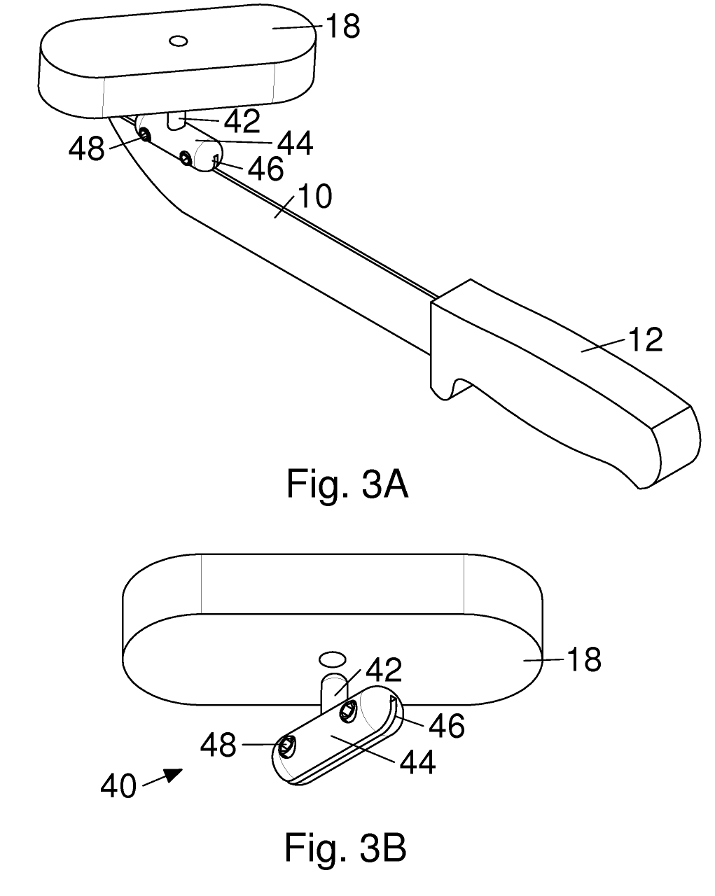

FIG. 3A illustrates an embodiment of the double handle knife with reversible means to attach a pivot post 42 to blade 10. Pivot post 42 is affixed to a stainless steel clamping body 44 by solder or other permanent means. Clamping body 44 has a slot 46 that fits over blade 10 and fastened with Allen head set screws 48. Secondary handle 18 is fitted over pivot post 42 and functions essentially as in the main embodiment by enabling the secondary handle 18 to pivot in a plane. The reversible design has the advantage that the secondary handle and pivot post 42 with clamping body 44 can be entirely removed, thereby converting the double handle knife into a conventional single handle knife for storage or for uses in which the pivot post might otherwise interfere with the cutting of an object.

FIG. 3B illustrates a rotating secondary handle attachment 40 comprising pivot post 42 attached to clamping body 44 and secondary handle 18 as per the double handle knife embodiment illustrated in FIG. 3A but without the blade and handle which provides the option for converting any single handle knife into a rotating double handle knife by inserting the top of a knife into slot 46 and tightening the Allen head screws 48.

Other secondary handles designs such as those illustrated in FIGS. 5A, 5B, 5C, and 5D may be used with the clamping body and pivot post. Furthermore, there are many ways to design a pivot post that reversibly attaches to a knife blade.

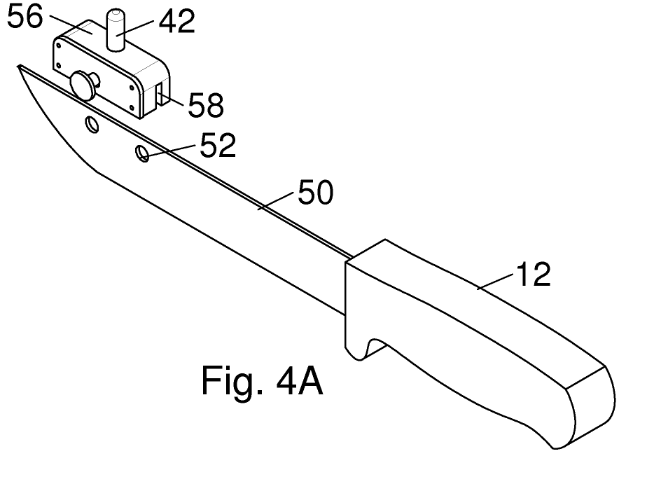

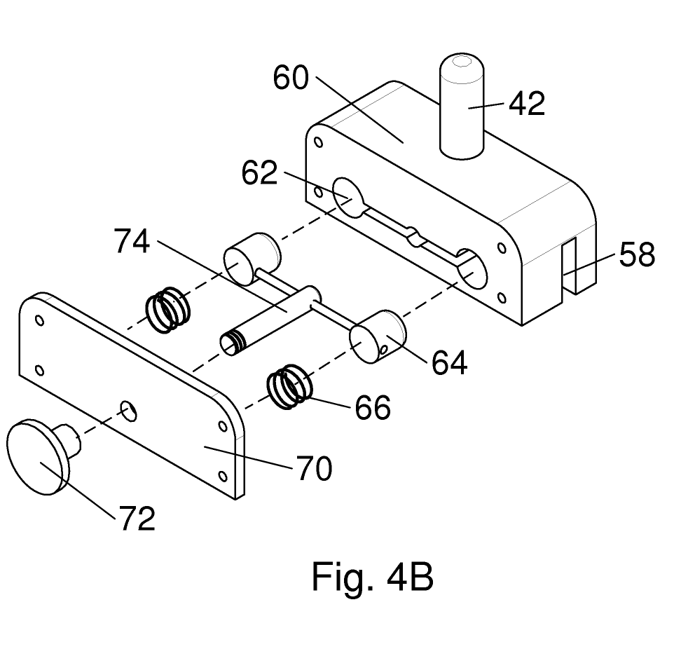

FIG. 4A illustrates a double handle knife embodiment with quick release means to attach a pivot post to a blade which utilizes a modification to the blade to help position and attach the pivot post. Blade 50 has two holes 52 and a primary handle 12 extending off the back end. A round bar pivot post 42 is permanently attached to a lower mounting unit 56 Lower mounting unit 56 has a slot 58 to fit over the blade 50 and is aligned for attachment such that holes 52 in blade align with holes 62 in lower mounting unit (FIG. 4B), being locked together by two inserted pins 64 (FIG. 4B). FIG. 4B is an exploded view of the lower mounting unit with pivot post showing the body 60 having two blind holes 62 into which inserts two pins 64 which pass through slot 58 under spring 66 tension against end plate 70. Pulling on a release knob 72 pulls attached connecting rods 74 for engagement and disengagement of pins 64 with slot 58, thereby providing a quick attach and release mechanism to blade 50. Secondary handles such as those described in FIG. 1 and FIGS. 5A, 5B, and 5C may then be used to attach to the pivot post 54.

FIGS. 5A, 5B, 5C and 5D illustrate examples of additional embodiments of the secondary handle that function with the various embodiments of the pivot post designs disclosed. These various embodiments may be made from molded plastic or other suitable means and have a hole 84, 94, or 103 or may have an inserted bushing or bearing to provide the hole to fit over the pivot post. Additionally, theses handles may use fasteners or tensioners as discussed for the press pad 18 version of the secondary handle. The long axis of these secondary handles is of sufficient length to allow multiple fingers to grip or press down on and the short axis or width sufficient length to press down on or grip around.

FIG. 5A illustrates a bi-level version of a secondary handle 80. Lower section 82 has a centrally located hole 84 and may function identical to the secondary handle 18 described in the primary operation of the main embodiment. The width of lower section 82 provides sufficient surface for the fingers to comfortably press down on but preferably less than two inches as wider widths introduce unnecessary side load as discussed for the primary operation of the main embodiment. To it, connected by two crossmembers 86 is an upper section 88 with a round hand grip enabling the non-dominant hand to wrap around for the application of downward pressure. The upper section 88 may be used when the non-dominant hand is not needed to control the food item being cut by providing even more versatility in the positions that the hands and arms may assume in cutting difficult objects such as frozen foods, pumpkins, etc. including a position in which the lower arm presses directly downward over the wrist with the non-dominant hand wrapped fully around the upper section 88 of the handle thus making fully available the power of the non-dominant arm and hand.

FIG. 5B illustrates a crosswise-grip version of the secondary handle 90 that provides the same feature and operation as the upper section in FIG. 3A but without the lower section feature. A base 92 with hole 94 to accommodate the pivot post has brackets 96 supporting round handle grip 98 upon which the non-dominant hand may wrap around.

FIG. 5C illustrates a T-grip version of the secondary handle 100 which comprises a base 102 with a hole 103 to accommodate a pivot post being connected to the round handle grip 101 by a connecting member 104 of thin cross section to pass with minimum discomfort between the middle and ring fingers when the fingers are used to wrap around the round handle grip.

FIG. 5D illustrates a safety secondary handle 105 with secondary handle 106 and attached safety guard 107. The safety guard which forms an arch and also has a rounded outer surface 109 prevents the knife from being stored with the secondary handle down and the cutting edge of the blade facing up and thus serves to prevent accidental injury. A safety guard may be placed on other handle designs such as secondary handle 80, 90 or 100.

The handles illustrated in FIGS. 5B and 5C are also useful for double handed sawing motions as for when using a serrated knife, and when used in conjunction with a clamping body as shown in FIG. 3B could conceivably convert a wood saw into a double handled saw.

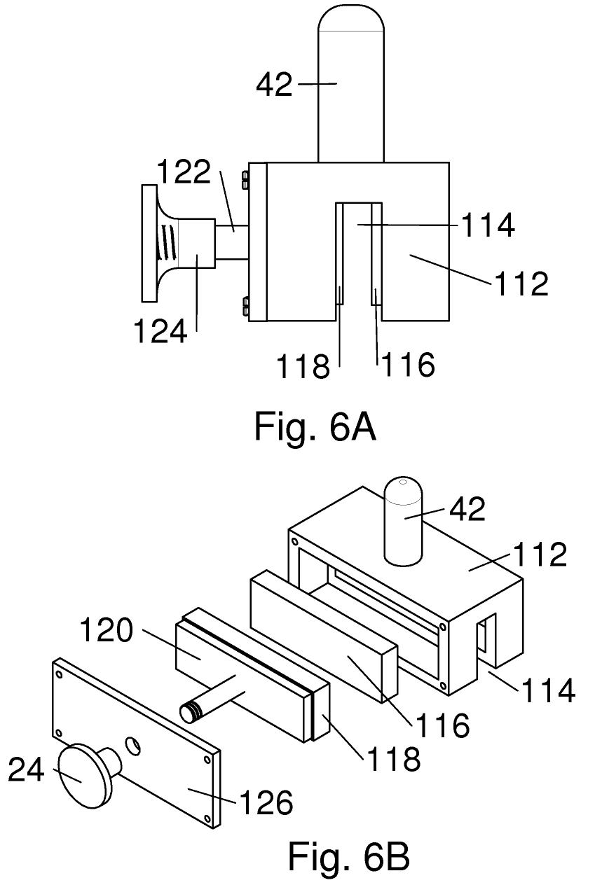

FIGS. 6A and 6B illustrate a pivot attached to a blade by means of a mounting unit with pressure plates. Pressure can be exerted by, but not limited to, coil springs, leaf springs, resilient pads, rubberized grooves, and/or magnetic attraction. Specifically, FIGS. 6A and 6B illustrate an embodiment utilizing magnet attraction to create pressure plate means of attachment in which the magnets are also the pressure plates.

FIG. 6A shows a side elevation view of a magnetic mounting unit 110 supporting pivot post 42 which may convert any single handle knife into a double handle knife. The housing 112 may have a removable side plate 126 for assembly and slot 114 within which are a floating flat bar magnet 118 opposite a fixed flat bar magnet 116. The floating flat bar magnet 118 has attached backing plate 140, attached to retracting rod 122, attached to knob 124. Pulling back on knob 124 facilitates the quick release or attachment of knife blades between magnets 116 and 118.

FIG. 6B shows an exploded detail perspective view of the magnetic mounting unit 110 of FIG. 6A.

Magnetic mounting unit 110 mounts to any knife without tools or modifications and can accommodate a variety of thicknesses due to the floating nature of magnet 118. Furthermore, it mounts to even stainless steel (with low magnetic attraction) or even non-metallic ceramic blades, since the two magnets 116 and 118 attract each other. Magnets 116 and 118 can be any appropriate magnetic material, such as, for example, but limited to, neodymium or samarium cobalt. The magnetic mounting unit with pivot post together with a secondary handle 18, 80, 90, 100, or 105 provides an pivoting secondary handle attachment, these together with blade 10, and primary handle 12 provide a pivoting double handle knife.

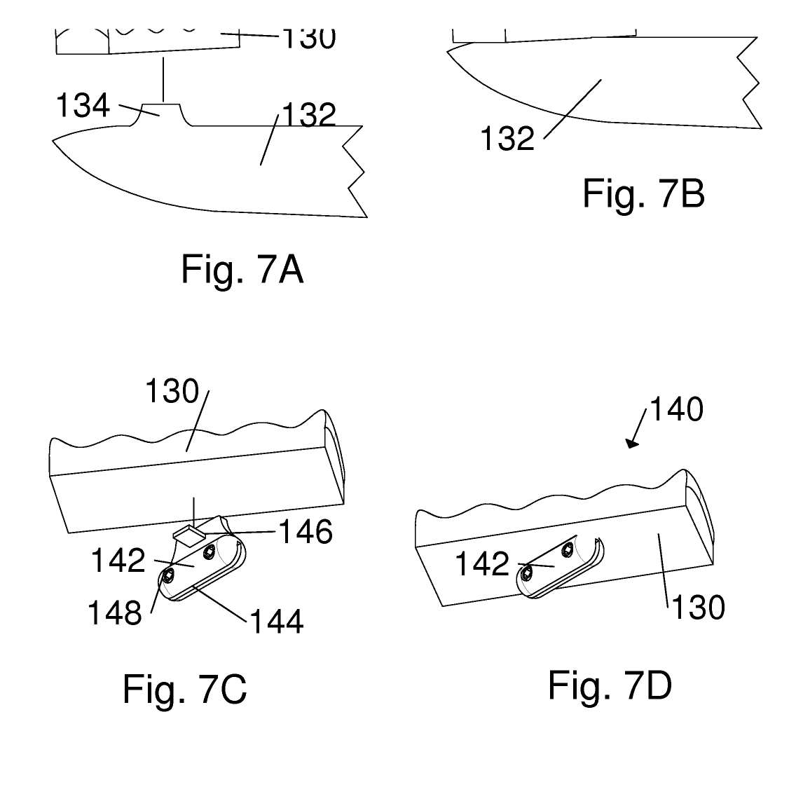

FIGS. 7A-7D illustrate fixed angle version of secondary handles. Other styles of handles such as those illustrated in FIGS. 80, 90, 100 could conceivable be used with the fixed means of attachment described in FIGS. 7A-7D.

FIG. 7A is a close-up exploded side-elevation view illustrating a double handle knife having a blade 132 with an integral tang 134. A second handle may be cast around the tang such that a fixed angle of the secondary handle 130 forms an angle (a) (see FIG. 2B) between 20 and 70 degrees to the blade 10 thereby providing an optimal angle for the cutting method described for the primary operation of the main embodiment. To further secure the molded handle, tang 134 may have a hole and a retainer pin could further be inserted before casting. FIG. 7B shows the second handle 130 cast around the tang on the blade 132.

FIG. 7C illustrates a close-up exploded perspective view of a fixed-angle secondary handle attachment which converts a singe handle knife into a double knife with a secondary handle at the fixed angle described in FIGS. 7A. The fixed angle attachment may have a clamping body 142 having a slot 144 that fits over a blade and may be secured with Allen screws 148. A plastic secondary handle 130 is cast around a tang with a retainer 146 protruding from clamping body 142 to secure the handle. FIG. 7D shows the attachment with the second handle 130 cast around the retainer 146.

Other means of attachment for a secondary handle at a fixed angle may be used such as one in which a secondary handle has a protruding lower section with a slot which fits over the blade and may be permanently or reversibly attached. The fixed angle secondary handle 130 is without the rotating advantage of the main embodiment which limits the overall positions that the hands and arms can assume in finding the most effective position in situations where the secondary hand is not needed to control the food item during the cut. Additionally, separate left handed and right handed knifes or attachments would be required if the handles were permanently attached. However, a potential advantage is that it may be cheaper to manufacture while still allowing the cutting method described for the primary operation of the main embodiment.

FIGS. 8A and 8B illustrate double handle knifes with tangs by which rotatable secondary handles are attached. FIG. 8A is a close-up exploded perspective view illustrating a double handle knife with a secondary handle 150 having a bushing 152 with a rotatable central core having a internal slot 154 which may removably fit over tang 156 on blade 158 thereby enabling the secondary handle 150 to pivot over the top of the blade 158.

FIG. 8B is a close-up exploded perspective view illustrating a double handle knife with a pivot post 170 with an internal slot 172 which may be permanently fitted over tang 156. Pivot post 170 made be made of plastic and cast over tang 156. For added retention the tang 156 may further have a hole with a pin inserted crosswise around which the plastic is molded. Second handle 166 has a hole 168 which fits over pivot post 170 allowing the rotation of the second handle. Fastening and tensioning means may be used to secure the handle in a favorite position. The advantage of these embodiments is that tang 156 being integrally stamped or cast with the blade 158 may be stronger than other attachment means.

FIG. 9A is an exploded detail perspective view illustrating an embodiment of a press pad 18 version of the secondary handle with tensioner. Secondary handle 180 has a tensioner hole 182 intersecting beyond hole 184 into which inserts beyond hole 184 a tensioner band with threaded housing 186 into which a tensioner knob 188 is threaded. When this presspad and tensioner assembly is inserted over the pivot post, the band 190 is tightened against the pivot post by turning the tensioner knob 188 thus having the effect of variably controlling the free rotation of the secondary handle around the pivot post or even locking it in position. The tensioner band can be easily removed for cleaning.

FIG. 9B is a close-up side-elevation view illustrating an embodiment of an O-ring 200 which fits into a groove 202 in a pivot post 204 which is attached to a blade 206 and provides tension to the rotation of a secondary handle so that it doesn't rotate out of position easily or slip off. Many alternative means of tensioning the handle are possible such as splitting of a pivot post and springing it outwards. Other versions of secondary handles 80, 90, 100 may have similar tensioning mechanisms and be used with the double handle knife or attachments.

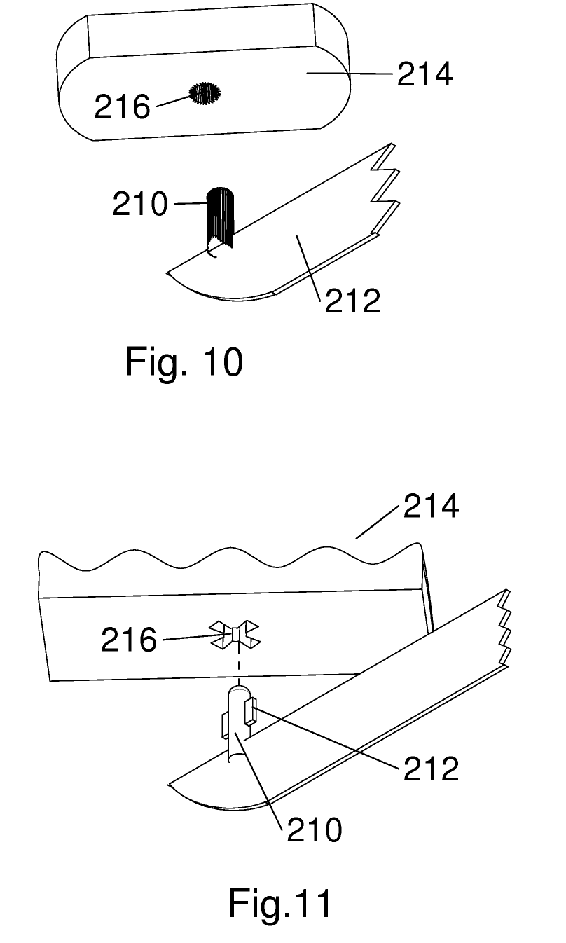

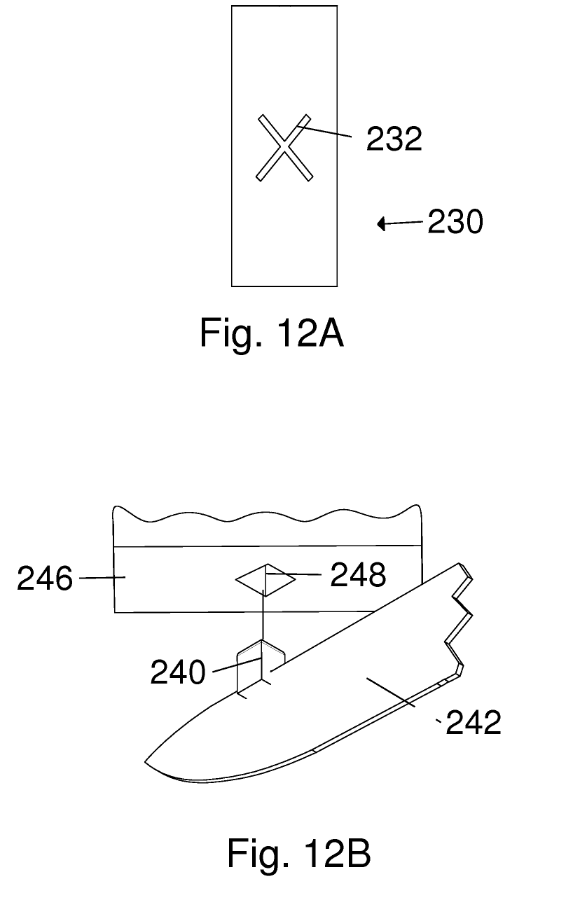

FIG. 10 illustrates an embodiment of a double handle knife having indexable means of rotation comprising a splined post 210 attached to blade 212 (shown in side elevation view) over which inserts a secondary handle 214 having mating internal splines 216 (shown in bottom view). If splined post 210 has 36 splines then 10 degree angles of the handle may be indexed by rotating the handle one tooth. The splined post may be permanently attached to the blade. Alternatively, the splined post may be reversibly attached to a blade by means of a clamping body, a magnetic mounting unit, or by other pressure means similar to the pivot post means of attachment, and may be used to convert a single handle knife into a double handle knife. The advantage of this system is that the ideal angle can be found for both positioning a food item and assisting with its cut and it will not slip or change. The disadvantage is that the handle needs to be removed and reinserted if a slightly different angle is desired. Other indexable means of rotation are shown in FIG. 12.

Fig. II is an exploded close-up perspective view illustrating an embodiment of a double handle knife with pivot post 220 having tabs 222 and a secondary handle 224 with hole having slots 226 which may be used to effectually limit the rotation of the double handle knife to within an ideal range for both controlling and chopping vegetables as described in the operation of the main embodiment of FIG. 1. Complimentary grooves are used to index the knife for right handed or left handed users.

FIG. 12 shows additional examples of indexable means of rotation. FIG. 12A is a bottom view illustrating an embodiment of a secondary handle 230 that attaches to a blade having at least two slots 232 into any one of which the tang of a blade may be inserted. The slots are positioned such that an angle (a) between 20 and 70 degrees may be formed (as described in FIG. 2). One slot forms angle (a) suitable for a right handed person and the other for a left handed person. Conveniently, the second handle is easily removable for storage.

FIG. 12B is a close-up exploded perspective view of a double handle knife having an second handle 246 with a square hole 248 which fits over a square post 242 permanently attached to a knife blade 242. The handle may be positioned with an angle (a) at 45 degrees (as described in FIG. 2B) for either a right handed person or a left handed person depending upon which orientation the handle is inserted in. There are many ways to make an indexable handle such as shown in FIG. 10 and FIG. 12 that are given by way of example.

The embodiments showing the means of attachment of a round pivot post as shown in FIG. 1-FIG. 4, FIG. 6 and FIG. 8 could similarly be used for the attachment of indexable means as shown in FIG. 10 or FIG. 12 for example. While preferred embodiments of the invention have been described using specific terms, such description is for present illustrative purposes only, and it is to be understood that changes and variations to such embodiments, including but not limited to the substitution of equivalent features or parts, and the reversal of various features thereof, may be practiced by those of ordinary skill in the art without departing from the spirit or scope of the following claims.

I claim:

1) A double handle knife comprising: a blade with a primary handle extending off the back end of said blade; said blade having a bottom cutting edge and a top edge; a secondary handle; said secondary handle having a long axis sufficiently wide to accommodate multiple fingers and a short axis; means to mount said secondary handle to the top of said blade such that an angle being between about 20 degrees and about 70 degrees may be formed between the long axis of said secondary handle and the long axis of said blade forward of their attachment; said angle being in a plane at about right angles to the plane of the blade, whereby the attachment of said secondary handle to the blade provides an angle optimal for the dual purpose of both positioning and cutting of food items.

2) The double handle knife of claim 1 wherein said means to mount said secondary handle to the top of said blade such that an angle being between about 20 degrees and about 70 degrees may be formed between the long axis of said secondary handle and the long axis of said blade forward of their attachment further comprises rotatable means wherein said secondary handle may be rotatable in a plane above the top of said blade, said plane being at about a right angle to the plane of said blade

3) The double handle knife of claim 2 wherein said rotatable means for mounting said secondary handle further comprises a pivot post extending from the top of said blade, said secondary handle with a hole of similar diameter to said pivot post, whereby said pivot post is engaged with said hole, thereby enabling the rotating motion of said secondary handle around said pivot post.

4) The double handle knife of claim 1 wherein said means for mounting said secondary handle further comprises permanent means.

5) The double handle knife of claim 1 wherein said means for mounting said secondary handle further comprises reversible means.

6) The double handle knife of claim 5 wherein said reversible means to mount said second handle to top of said blade further comprises attaching said secondary handle to a clamping body, said clamping body being slotted on a bottom thereof to fit on said blade, tightening at least one screw on a side of said clamping body to secure said blade.

7) The double handle knife of claim 5 wherein said reversible means to mount said second handle to top of said blade further comprises attaching said secondary handle to a lower mounting unit, modifications to said blade to facilitate mounting and positioning of said lower mounting unit to said blade.

8) The double handle knife of claim 5 wherein said reversible means to mount said second handle to top of said blade further comprises attaching said secondary handle to a mounting unit, said mounting unit having pressure plate means to attach to a blade, means to retract said pressure plate means, whereby said mounting unit with attached secondary handle quickly releases from said blade.

9) The double handle knife of claim 8 wherein said pressure plate means to attach said mounting unit to a blade further comprises a housing having a slot engageable over said blade, said slot having a fixed flat bar magnet and a floating flat bar magnet, each magnet attractable to each other, and means to retract said floating bar magnet.

10) The double handle knife of claim 1 wherein said means for mounting said secondary handle further comprises mounting to an integral tang extending upwards from the top of said blade.

11) The double handle knife of claim 1 wherein said secondary handle is selected from a group consisting of a press pad version, a dual function handle version, a crosswise-grip version, a T-grip version, and a safety guard version.

12) The secondary handle of claim 1 wherein said secondary handle has tensioning means to limit the free rotation of said secondary handle.

13) The double handle knife of claim 1 wherein said rotatable means has restricted range of motion in plane.

14) The double handle knife of claim 1 wherein said secondary handle is secured to said blade by fasteners.

15) The double handle knife of claim 2 wherein the means of rotation of said second handle further comprises indexable means of rotation.

16) The double handle knife of claim 1 wherein said means to mount said secondary handle to the top of a blade further comprises mounting said secondary handle at a fixed angle.

17) A secondary handle attachment comprising a secondary handle, said secondary handle having a long axis sufficiently wide to accommodate multiple fingers and a short axis; reversible means to mount said secondary handle to the top of a blade at an angle being between about 20 degrees and about 70 degrees formed between the long axis of said secondary handle and the long axis of the blade forward of their attachment, said angle being in a plane at about right angles to the plane of the blade whereby the attachment of said secondary handle to the blade provides an angle optimal for the dual purpose of both positioning and cutting of food items.

18) The secondary handle attachment of claim 17 wherein said reversible means to mount said secondary handle to the top of a blade further comprises mounting said secondary handle at a fixed angle.

19) The secondary handle attachment of claim 17 wherein said reversible means to mount said secondary handle to the top of a blade further comprises rotatable means to mount said secondary handle.

20) The secondary handle attachment of claim 19 wherein the means of rotation of said second handle further comprises indexable means of rotation.

21) The secondary handle attachment of claim 17 wherein said secondary handle is selected from a group consisting of a press pad version, a dual function handle version, a crosswise-grip version, and a T-grip version.

22) The rotating secondary handle attachment of claim 19 wherein said rotatable means to reversibly mount said secondary handle to a top of a blade further comprises a pivot post, a secondary handle with a hole, whereby said pivot post attaches to a blade, said pivot post inserts into said hole, thereby enabling the rotating motion of said secondary handle in a plane.

23) The secondary handle attachment of claim 17 wherein said reversible means to attach a secondary handle to the top of a blade further comprises attaching said secondary handle a clamping body, said clamping body being slotted on a bottom thereof to fit on a blade, tightening at least one screw on a side of said clamping body to secure a blade.

24) The secondary handle attachment of claim 17 wherein said reversible means to attaching said secondary handle to the top of a blade further comprises attaching said secondary handle to a mounting unit, pressure plate means to attach said mounting unit to a blade, and means to retract said pressure plate means.
